(19) United States
(12) Patent Application Publication
(10) Pub. No.: US 2026/0213543 A1
(43) Pub. Date: Jul. 23, 2026

(54) MULTI TERMINAL HVDC CONTROL METHODS AND SYSTEMS

(71) Applicant: SCOTTISH HYDRO ELECTRIC TRANSMISSION PLC, Cumbernauld (GB)

(72) Inventors: Dong CHEN, Cumbernauld (GB); Benjamin MARSHALL, Cumbernauld (GB); Colin FOOTE, Cumbernauld (GB); Suresh RANGASAMY, Cumbernauld (GB)

(21) Appl. No.: 19/140,040

(22) PCT Filed: Dec. 14, 2023
(86) PCT No.: PCT/GB2023/053251

§ 371 Date: Jun. 17, 2025

(30) Foreign Application Priority Data
Dec. 21, 2022 (GB) 2219373.4

(51) Int. Cl. H02J 3/36; H02J 3/38; H02J 101/28

(52) U.S. Cl. CPC H02J 3/36; H02J 3/381; H02J 2101/28

(57) ABSTRACT

A method for controlling or operating High Voltage Direct Current (HVDC) converters within a multi-terminal HVDC system, multi-terminal HVDC systems implementing such controls, controllers and computer software for same. The outputs of the HVDC converters are controlled by providing each HVDC converter with a respective or converter specific DC voltage reference. A feedback signal is determined for each HVDC converter, and the converter specific feedback signals comprise a modification to the DC voltage reference for the respective converter. Determining the converter specific feedback signals comprises analysing terminal characteristics of each converter and determining an index indicative of a margin against loss of equilibrium, or modelling terminal characteristics of each converter as an equivalent circuit based on or representing the response of that HVDC converter to a modification of its voltage reference for a given operating state. HVDC converter terminal characteristics can include impedance, voltage droop, power, branch current and nodal voltage, etc.

The present invention relates to the field of power transmission and, more specifically, the present invention concerns improvements to methods of controlling High Voltage Direct Current (HVDC) converters within a multi-terminal HVDC system, and multi-terminal HVDC systems implementing such controls.

### BACKGROUND TO THE INVENTION

Mass utilisation of offshore wind energy has been identified as a fundamental enabler of the UK government's net-zero strategy for tackling climate change [1]. Within the Holistic Network Design [2] of the United Kingdom system to 2030, a range of Multi-Terminal High Voltage Direct Current (MT-HVDC) transmission systems have been considered as an effective and economical approach to transmit bulk offshore power to the existing onshore power network [3]. These more extensive Direct Current (DC) networks which are set to emerge, in a staged manner, and are doing so coincident with an unprecedented growth of demand for HVDC worldwide and the need for Transmission System Operators (TSOs) to describe staged growth of and control paradigms for these DC networks. In this context, the need for multi-vendor (MV) MT-HVDC solutions becomes increasingly likely.

Within the UK, the Caithness Moray Shetland project (C-M-S) [4] is the first example of a multi-terminal Voltage Source Converter (VSC) HVDC system outside of China, although this has delivered by a single vendor. In the scheme used by some pilot projects involving multiple vendors, the vendors may be required to disclose information relating to control design and/or to modify their designs to make them compatible with other converters. This “open” approach is not practical within the UK and other international markets as this information is usually proprietary, confidential and/or otherwise unknowable.

There is therefore a need for a practical and vendor-agnostic approach to Multi-Vendor Multi-Terminal (MVMT) HVDC control which does not require disclosure or otherwise obtaining knowledge of individual converter design. The principal challenge of MVMT control interoperability is how to ensure HVDC converters of different vendor solutions can work together and maintain stability in a coupled DC network without sharing details of their internal designs, beginning at planning and procurement stage [5], and then being supported across detailed design testing, operational, and refurbishment/modification stages of the asset lifecycle of a MVMT-HVDC system.

A challenge within any MT-HVDC control is that unlike an alternating current (AC) system, there is no common network parameter such as AC frequency to inherently align behaviours within that DC network, and as a result many approaches will instead employ either a single point of network control referencing a single HVDC converter and its control of the DC system, or introducing/deriving a common general variable that all converters may then reference. Both of these approaches whilst viable require a strong understanding of the HVDC converter design and behaviour referencing proprietal areas of control structure, and can introduce unwelcome dependencies upon the resilience of that control system or its communication in practical operation.

By introducing constant power terminals driven by the dynamics of offshore wind or onshore TSO dispatch, a MTDC system is a non-linear system. Aligning with Lyapunov's First method [6], stability assessment of a non-linear system includes two successive components, namely the existence of equilibrium and the sufficiency of damping. Although there has been significant research into the stability of a DC system in both aspects, there has to date been no comprehensive solution that can ensure both aspects without detailed knowledge of the internal control of the participating converters. Hence, it is presently impossible to fully support industrial application of MVMT HVDC.

Accordingly, it is an object of at least one aspect of the present invention to provide vendor-agnostic control of MT-HVDC systems that might enable widespread adoption of MVMT HVDC systems. The invention may be implemented in a method of controlling or operating a plurality of HVDC converters, a controller for a multi-terminal HVDC system, a multi-terminal HVDC system, and corresponding computer program products.

Further aims and objects of the invention will become apparent from reading the following description.

### SUMMARY OF THE INVENTION

According to a first aspect of the invention, there is provided a method for controlling (or operating) a plurality of HVDC converters within a multi-terminal HVDC system, the method comprising:
controlling the outputs of the plurality of HVDC converters by providing each HVDC converter with a respective (or converter specific) DC voltage reference;
determining a respective feedback signal for each of the plurality of HVDC converters wherein the (converter specific) feedback signals comprise a modification to the DC voltage reference for the respective converter;
wherein determining the respective (converter specific) feedback signals comprises analysing terminal characteristics of each converter and determining an index indicative of a margin against loss of equilibrium.

This methodology may involve and imply definition of both converter and network equivalent impedance and control effect across fundamental and other relevant control frequencies, accounting for contingency analysis. HVDC converter terminal characteristics may include impedance, voltage droop, power, branch current and nodal voltage, etc.

Preferably, the index quantifies the interactions amongst voltage droops between the plurality of HVDC converters. Optionally, the index indicates a stability margin against DC power transfer.

Preferably, the modification to the DC voltage reference is determined to optimise steady state operation (or stability) of the multi-terminal HVDC system.

Preferably, the method comprises modelling the terminal characteristics of each converter as an equivalent circuit, which may be expressed as a Norton equivalent circuit or a Thevenin equivalent circuit based on or representing the effect that HVDC converter has in response to a modification of its voltage reference for a given operating state. This allows the control method to be implemented without detailed information about the converters.

Preferably, the method comprises determining HVDC system characteristics by constructing a matrix of extended impedance or extended matrix of conductance for the system.

Preferably, the method comprises determining DC voltage droop characteristics for each HVDC converter.

Preferably, the method comprises determining an initial value of equilibrium. Preferably, the method comprises normalising the index against loss of equilibrium. Preferably the equilibrium may be identified based on both intact and contingency states of the HVDC network, such that the state may not represent an optimised position for a given operating state, but rather may represent a state optimised in its secure operation in response to change and/or contingency in its operation.

Preferably, the method comprises determining branch currents and nodal voltages within the system. The branch currents and nodal voltages may be received at a central controller configured to implement the method.

Preferably, the control method may be applicable to a range of differing HVDC multi-terminal topologies—including symmetrical monopole, Full Bipole, and rigid Bipole (without earth return capability). The approach to effect characterisation of the HVDC converter accordingly may apply to each pole converter terminal individually and the equivalent measurement and characterisation of the neutral current terminal is further implied.

Preferably, the multi-terminal HVDC system is a multi-vendor multi-terminal HVDC system. However, this is not a necessity—the inventive concept may optionally be applied to single-vendor multi-terminal systems.

The multi-terminal HVDC system may be comprised in an HVDC transmission system. The HVDC converters may be comprised in an interface or interfaces between one or more HVDC power lines and one or more AC generation systems and/or one or more AC grid networks. The one or more AC generation systems may comprise one or more offshore wind turbines or farms. The one or more AC grid networks may comprise one or more onshore AC grid networks.

According to a second aspect of the invention, there is provided a method for controlling (or operating) a plurality of HVDC converters within a multi-terminal HVDC system, the method comprising:
controlling the outputs of the plurality of HVDC converters by providing each HVDC converter with a respective (or converter specific) DC voltage reference;
determining a respective feedback signal for each of the plurality of HVDC converters wherein the (converter specific) feedback signals comprise a modification to the DC voltage reference for the respective converter;
wherein determining the respective (converter specific) feedback signals comprises modelling terminal characteristics of each converter as an equivalent circuit based on or representing the response of that HVDC converter to a modification of its voltage reference for a given operating state.

Optionally, determining the respective (converter specific) feedback signals comprises analysing terminal characteristics of each converter and determining an index indicative of a margin against loss of equilibrium.

Embodiments of the second aspect of the invention may comprise features of or corresponding to the preferred or optional features of the first aspect of the invention.

According to a third aspect of the invention there is provided a controller for a multi-terminal HVDC system, the controller adapted or configured to perform the method of the first aspect.

Embodiments of the third aspect of the invention may comprise features of or corresponding to the preferred or optional features of the first or second aspects of the invention or vice versa.

According to a fourth aspect of the invention there is provided a multi-terminal HVDC system comprising a plurality of HVDC converters and a controller according to the second aspect.

Preferably, the system comprises at least one HVDC power line, at least one HVDC converter between the at least one HVDC power line and an offshore wind farm, and at least one HVDC converter between the at least one HVDC power line and an onshore AC grid.

The multi-terminal HVDC system may be a multi-vendor multi-terminal HVDC system.

The at least one HVDC converter may comprise at least one voltage source converter. Preferably, the at least one HVDC converter comprises a nodular multilevel converter.

Embodiments of the fourth aspect of the invention may comprise features of or corresponding to the preferred or optional features of the first, second or third aspects of the invention or vice versa.

According to a fifth aspect of the invention there is provided a computer program comprising instructions which, when executed by a computer, cause the computer to carry out the method of the first or second aspect.

According to a sixth aspect of the invention there is provided a computer readable medium or data carrier comprising the computer program of the fifth aspect.

According to a seventh aspect of the invention there is provided a data carrier signal carrying the computer program of the fifth aspect.

Embodiments of the fifth to seventh aspects of the invention may comprise features of or corresponding to the preferred or optional features of any other aspect of the invention or vice versa.

### BRIEF DESCRIPTION OF THE DRAWINGS

Aspects and advantages of the present invention will become apparent upon reading the following detailed description and upon reference to the following drawings (like reference numerals referring to like features) in which:

FIG. 1 is a schematic representation of an offshore multi-terminal multi-vendor (MTMV) high voltage direct current (HVDC) network;

FIG. 2 is a schematic representation of a control architecture of a MTMV HVDC network

FIG. 3 is a schematic representation of an MTMV HVDC component model showing (a) nodal equivalent of each node within an MTMV HVDC network, (b) voltage dependent control and (c) voltage independent control;

FIG. 4 is a schematic representation of an exemplary three terminal bipolar HVDC network used for benchmarking by time domain simulation;

FIG. 5 illustrates the results of power ramp tests carried out based on the benchmark system shown in FIG. 4 (a) with initial droop coefficients and (b) with reduced droop coefficients; and

FIG. 6 illustrates the results of a comparison between pseudo steady state and electro-magnetic transient modelling based on the power ramp test represented in FIG. 5(b).

### DETAILED DESCRIPTION OF PREFERRED EMBODIMENTS

As discussed in the background to the invention above it is desirable to provide methods and control concepts, and systems implementing them, which enable multi-terminal multi-vendor operation of VSC-HVDC networks.

The applicant has identified several factors limiting the functionality and preventing widespread adoption of MT HVDC systems. These include, but are not limited to, the following (at least one of which the invention and embodiments thereof seek to overcome).

An MT HVDC system has no inherent operational reference which means that using conventional approaches requires that the system is enforced by a single converter which defines the overall network behaviour or requires communication and/or interaction between converters. Communication between converters introduces its own challenges. Converter design is also highly vendor-specific so control solutions which optimise the converters of one vendor may be incompatible with those of another, so approaches which might work in a single-vendor MT HVDC system (or an “open” MVMT HVDC system such as implemented in China) are generally unworkable in relatively “closed” MVMT HVDC systems. It is also impractical to implement such approaches during online operation. Furthermore, complex systems present a computational problem in that it is time consuming to compute variable cases, and engineering expertise is necessarily high on the part of the end user to implement.

In response, the applicant has developed functional models and control concepts that can be implemented in control methods and systems which can facilitate interfacing in a vendor-agnostic manner with HVDC converter designs and control systems. As will be explained below, the inventive concept can be applied at any stage in the planning, specification, testing and operation of an HVDC network without requiring any knowledge of the internal design of converters (which knowledge might be proprietary, confidential or otherwise unknowable).

To assess or aid in assessing control interactions in a MVMT-HVDC network, the applicant has developed a method to quantify the interactions between converters against loss-of-equilibrium. The method seeks to define the effect of converter response to a variation in terminal voltage such that conditions of stable operation may be identified and (if appropriate) directed accordingly, and this can be done without knowledge of specific converter designs. This involves representation of the encrypted control detail within a model or replica in the form of an equivalent control droop response to the voltage change, for a given operating condition. Within that data provision, this method can quantify the compatibility of multiple droop coefficients considering the impact of operating point and network metrics. Aligning with the principle of Lyapunov's First method, this step will serve as a prerequisite and is decoupled from the assessment of small-signal before completing stability assessment for steady state.

In summary, the invention (and embodiments thereof) provides methods and systems within which individual convertors can contribute to an overall de-risked voltage profile across a multi-terminal DC system without reliance upon continual updating of control across communication which respects the individual convertor control. A multi-terminal control approach is applied based on receipt of measurements of voltage and power flow within the DC system, together with other time evolving dispatch information of the DC network and current operating points of the DC system provides adjustment to individual DC voltage references to HVDC converter controllers based on an impedance-based contingency and stability assessment of the DC system. The control concept focuses on characterising the DC voltage droop characteristic of the HVDC convertor and the small signal impedance characteristic of the HVDC converter that acts upon the DC system for a given operating point rather than relying on intimate knowledge of the individual converters that delivers these and other behaviours of the convertor. By this approach the multi-terminal control is able to assess interactions between converters in a Direct Current (DC) network; and set an overall operating state of the multi-terminal DC network which is inherently stable to current and evolving operational conditions, even if not subject to further continuous updates; which serve as a course correction to that overall operating state of the multi-terminal system.

Within this method, a safety margin against loss of equilibrium can be calculated with terminal behaviour of converters, i.e., without the knowledge of internal designs of converters, which are generally proprietary, confidential or otherwise unknown or unknowable. This serves to provide further protection to loss of communication or other credible disruptions in the network disruption. Hence the operating condition is not necessarily the most optimum from other measures—but is intended to be the most robust for the power flow condition and operating states of the converters present at the time.

Application of the mathematical basis of control together with the associated model of this control forms a basis for evaluating, testing and defining the individual vendor approaches to its implementation in practical power system application. The concepts described herein are not specific to any particular converter or controller can be applied to the planning, specification, testing and operating of a High Voltage DC (HVDC) network, and indeed may be extended to low-voltage, or medium voltage DC systems.

As will be explained in further detail below, features of an implementation of the inventive concept may include extracting the DC components (i.e., 0 Hz) of network metrics and the terminal behaviours of the converters. The converter terminal characteristics (including constant impedance, voltage droop control, constant power, and constant current) may be linearised at 0 Hz and assumed to behave as (for example) Thevenin or Norton equivalent nodes. Optionally, switching stations can be modelled as terminals without sources. System characteristics may be extracted by constructing a matrix of extended impedance (which incorporates the model of all terminals forming a DC network of n nodes). Existence of an initial value of equilibrium to the DC network may be determined and the resulting value of the determinant can be used as an index to indicate the margin against loss of equilibrium. The index may be normalised against loss of equilibrium to generically index an HVDC network of any topology and/or control structure.

In summary, benefits include simplicity in implementation, assessment, and characterisation. The proposed methods may provide for autonomous function with low processing demands resulting in shorter control cycles. Provision of a one-dimensional (normalised) index allows fair and explicit comparison between like and unlike/dissimilar converters, and as a reference signal is convenient and simple for vendors to react or respond to, for example to optimise the converter design and/or control responsively.

### Benchmark System

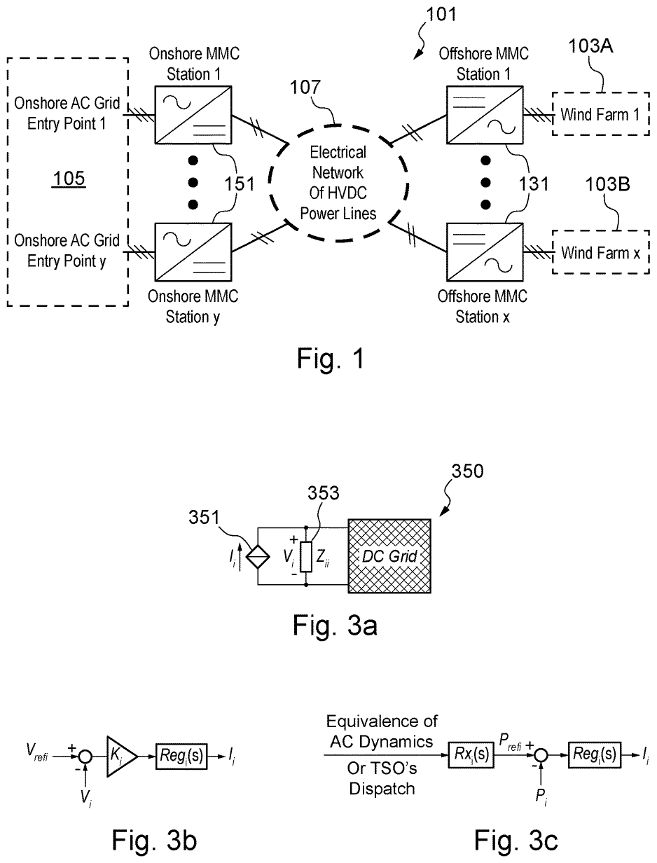

A schematic representation of a generic multi-terminal multi-vendor (MTMV) high voltage direct current (HVDC) network 101, interconnecting offshore windfarms 103A,103B (representative of x wind farms) and an onshore AC transmission network 105, is shown in FIG. 1 and is used herein to demonstrate the inventive concept and features of a possible implementation of the control methods and systems contemplated herein.

The network illustrated in FIG. 1 includes two types of HVDC terminal, namely an offshore interfacing Wind Farm (WF) terminal 131 and Onshore (OS) terminal 151. In this example, the WF terminal 131 comprises a modular multilevel converter (MMC) which typically controls the AC voltage and frequency of the offshore network to which it is connected, and the OS terminal 151 comprises a MMC which regulates the DC voltage of the HVDC link provided by the interposed electrical network of HVDC power lines 107. For the avoidance of doubt, these converters 131,151 convert, firstly, AC voltage generated by the offshore network 103A,103B to DC voltage for transmission via HVDC power lines 107 to, secondly, subsequent conversion to AC voltage for onshore distribution (e.g., directly or indirectly to an onshore AC grid 105). While MMC converters are the most common type of voltage source converter (VSC) for HVDC applications it will be understood that any voltage source converter (VSC) type may be employed.

In principle the more convertors participate in the voltage control of the DC network, the greater the flexibility of this control will be; but the inventive concept is enabled provided there is at least one terminal which provides this capability whereby the overall DC network is controlled. However, the control of the DC network is subject to practical restrictions in respecting onshore and offshore AC system requirements.

For the offshore AC system providing the offshore wind farm interface (i.e. the respective MMC), it is normally necessary for grid forming control to be established where the HVDC convertor defines the frequency and the voltage of the offshore network (e.g. connected windfarm), thereby representing to the DC system a fixed power flow independent of DC dynamics in its steady state operation. This needs to be accounted for in the overall solution of the DC network but does not provide further flexibility in defining that solution but rather operates as a consequence of the DC voltage as defined elsewhere within this system, within the range of DC voltage available. Onshore the connection interfaces may be operated to a specific intended power flow which does not preclude being set based on a droop power control of the voltage within the DC network, but equally would be dependent also on the operating state of the onshore AC system at the time. Direct control of the AC system, for example at the point of offtake, can be introduced but in the example above would then limit the MVMT network to one point of voltage control and an associated vulnerability to its loss.

### Architecture of System Control

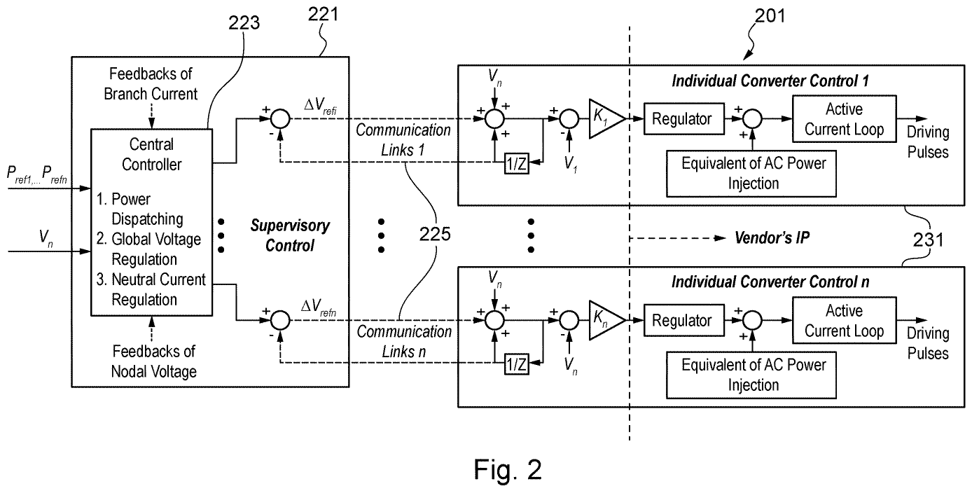

A generic control architecture 201 is illustrated in FIG. 2 comprising a number n of individual converters 231. As shown, each converter station comprises inner loops of current control, or equivalent. The characteristics of lower-level design for each converter are aggregated and “masked” on the assumption that the designs will be proprietary, confidential or otherwise unknowable. The designs may include (voltage) regulators of current loops, AC voltage controls, modulation schemes, voltage balancing among sub-modules/arms/phases, main circuit, and other controls related to topology and the convertor operating principles in respect to both the AC and DC systems.

At given extreme conditions of either the DC network or the associated converter operation the expression of control may be exposed to non-linearity and the objective of the supervisory control is to ensure that these are not conditions that either the network nor individual convertors are exposed to in steady state or post-steady-state operation; the later representing a range of N-1 and other contingencies informing control priority and associated control margin.

The functions of supervisory control 221 are implemented by a central control unit 223 (or controller), which would for example be owned and/or operated by a transmission system operator (TSO). Conversely, the individual converters 231 may be wholly owned and independently operated by one or more third parties and may be provided by a range of vendors. As discussed above, the converter designs may therefore be proprietary, confidential or otherwise unknowable to the TSO, while the TSO desires to be able to control these converters directly it is likely this will not be possible. As such, control per se is delegated to the vendors (and more specifically to the converters) but the criteria, feedback signals, etc. are determined by/for the TSO and provided to individual converter controls for processing, e.g. by providing each converter with a DC voltage reference and by updating or providing a modification 225 to that DC voltage reference as required.

Based on feedback measurements of nodal voltages and branch currents along with input orders of power dispatching and nominal voltage, the outputs of the supervisory control will update the incremental values of DC voltage reference (AV_{ref}) to each of the converters 231 via respective communication links.

As the name implies, the purpose of the supervisory control 221 is to course-correct the operation of the overall system towards a steady state condition which is both stable and contingency robust. In this manner the concept is not dependent on the reliability of communication links, as operation for a given condition would remain stable for that operating condition and a range of credible situations ahead of any further update. Actions via the supervisory control would act to (slowly) modify voltage reference responses by the associated converter terminals to correct and drive more secure new operating conditions for the DC network, and transitions of operating state can be implemented via a forward guidance of slow changes over an extended period of time, for example achieving a ramping up or down of power flow.

### Nodal Model of DC Network

For assessment of interoperability, an MTMV-HVDC system is modelled or otherwise represented as an electrical circuit with shunt controllable sources at selected nodes. The nodes represent the positions of converter terminals and junctions of cables within the DC network.

Each branch of the circuit characterises the aggregated impedance of a corresponding point-to-point DC cable between two nodes and the connected series elements, such as DC circuit breaker, DC reactor, etc. if applicable.

Each node is modelled as a Norton Equivalent Circuit 350, as FIG. 3 (a) shows. The current source 351 of the Norton Equivalent Circuit 350 is controllable and represents the active control of the converter. The shunt impedance 353 represents the shunt passive elements at the node, e.g., the aggregated capacitances of MMC cells and inductances, dump resistor, etc. DC junctions (e.g., switching stations without connected converter(s)) are modelled as special nodes where the order of the controllable current source is zero (i.e., without any source). Note that in other embodiments the converter terminal characteristics may be modelled as Thevenin Equivalent Circuits, or indeed any other relevant/workable representation.

During operation, the nodes of converter terminals are categorized into two types, namely voltage-dependent and voltage-independent.

The model of voltage-dependent control is demonstrated in FIG. 3(b). Assuming the modulation process of the HVDC converter is linearized, the S-domain admittance of converter control is modelled as the product of Kᵢ and Regi(s) such that:

$$\{ \begin{matrix}{K}_{i} = \frac{{I}_{i} ( s )}{{V}_{refi} ( s ) - {V}_{i} ( s )} {\vert}_{S = 0} \\ {Reg}_{i} ( s ) = \frac{{I}_{i} ( s )}{{K}_{i} [ {V}_{refi} ( s ) - {V}_{i} ( s ) ]}\end{matrix} \qquad ( 1 )$$

where Iᵢ, V_{refi}, and Vᵢ represent the reference voltage order, terminal voltage, and output current of active control at node i. Therefore, when it is under voltage dependent control, the order of the controllable current source of a voltage-dependent node can be expressed as:

$${I}_{i} ( s ) {\vert}_{s = 0} = {K}_{i} ( {V}_{refi} - {V}_{i} ) \qquad ( 2 )$$

For a node with voltage-independent control, we focus on control of constant power as constant DC current control is rare and does not change nodal shunt impedance at 0 Hz. The equivalent power order is assumed to be a result of either a local converter control mechanism, e.g. autonomously balancing the connected AC network [9] or the dispatch order of operator. In both cases, the output power is determined by a one-way input to the DC system. Projecting to the control mechanism shown in FIG. 3(c), at steady state, we have:

$$\{ \begin{matrix}{{Rx}_{i} ( s ) \vert}_{s = 0} = 1 \\ {{Reg}_{i} ( s ) \vert}_{s = 0} = 1 \\ {{{I}_{i} ( s ) \vert}_{s = 0} = {P}_{refi} ( s ) / {V}_{i} ( s ) \vert}_{s = 0}\end{matrix} \qquad ( 3 )$$

### Branch Model of DC Network

For each DC branch, including both the positive and negative poles to give a return path, between Node i and j, the aggregated impedance Zᵢⱼ(s) at steady state is written as:

$${{Z}_{ij} ( s ) \vert}_{s = 0} = {R}_{ij} \qquad ( 4 )$$

where Rᵢⱼ(i≠j) is the aggregated resistance of the branch, including return; Rᵢⱼ is the shunt resistance at the ith node.

### Network Model at Steady State

By interconnecting n nodal equivalents as shown in FIG. 3(a) with a branch return in between any two nodes, the equilibriums of an n-node HVDC network can be characterized using Kirchhoff's law [10] for voltage as:

$$G \text{?} = \text{?} \qquad ( 5 )$$

where G is an n×n symmetrical matrix of network conductance (i.e., network admittance at 0 Hz). [symbol] is the n-dimension vector of nodal voltage; its ith (0<i≤n) dimension Vᵢ represents the voltage measurement of ith node. Similarly, [symbol] is the n-dimension vector of nodal current injection from converters. Representing the element of G at ith (0<i≤n) row and jth (0<j≤n) column with Gᵢⱼ gives:

$$\{ \begin{matrix}{G}_{ji} = {G}_{ij} = - \frac{1}{{R}_{ij}} \\ {G}_{ii} = {\sum }_{i = 1}^{n} \frac{1}{{R}_{ij}}\end{matrix} \qquad ( 6 )$$

The ith component of [symbol] is Vᵢ and ith component of [symbol] is Iᵢ. Considering the control in FIG. 2 and FIG. 3, the vector of nodal current injection can also be expressed as:

$$\text{?} = K ( \text{?} - \text{?} ) + INV \text{?} \qquad ( 7 )$$

where K is an n×n diagonal matrix of droop gain (supervisory droop control?). Its diagonal element at ith row Kᵢ (0<i≤n) represents the voltage droop coefficient of the ith node; if the node is not droop controlled, then Kᵢᵢ=0. [symbol] is an n-dimension vector of the reference value of droop control (coefficient?), whose ith (0<i≤n) component is V_{refi} (the voltage of the ith node); INV is an n×n diagonal matrix, whose diagonal element INV, (0<i≤n) is

$$\frac{1}{{V}_{i}} ;$$

[symbol]

is an n-dimension vector of the arbitrary power injection at all the nodes, whose ith (0<i≤n) component P_{refi} represents the expected power injection at the ith node. P_{refi} is either determined by a dispatching signal from supervisory control function, or an embedded function of the converter at ith node.

Substituting (7) into (5), one can define a function:

$$F ( \text{?} , \text{?} ) = ( G + K ) \text{?} - K \text{?} - INV \text{?} = 0 \qquad ( 8 )$$

Treating vector [symbol] as a dependent variable driven by the independent variable [symbol] , then the corresponding function of solution to [symbol] , [symbol] =ƒ( [symbol] ), is implicitly defined by the function of F( [symbol] , [symbol] ).

If a converter node is designed to operate either as voltage-independent or voltage-dependent exclusive, then this assumption can be mathematically expressed as

$${K}_{i} {P}_{refi} = 0 \qquad ( 9 )$$

### Assessing Existence of Equilibrium

Based on the definition in (9), for a practical design of HVDC network, the function of F( [symbol] , [symbol] ) is a linear combination of polynomial functions and reciprocal functions; hence it is continuously differentiable and analytic [11] with respect of all elements of [symbol] and [symbol] . By applying the theorem of implicit function [12] to (9), there must be a unique function of ƒ( [symbol] ) in the neighbourhood of (or an open set that contains) an operating point ( [symbol] , [symbol] ), as long as the following two conditions both stand:

Condition (I): One equilibrium does exist at the operating point of ( [symbol] , [symbol] ).

Condition (II): The Jacobi matrix of F( [symbol] , [symbol] ) with respect of [symbol] is not singular at the equilibrium. That is:

$${\vert \frac{\partial F ( \text{?} , \text{?} )}{\partial {V}_{1} , \partial {V}_{2} , … , \partial {V}_{n}} \vert \vert}_{\vec{V} = \vec{{V}_{0}} , \vec{{P}_{ref}} = \vec{{P}_{ref 0}}} \neq 0 \qquad ( 10 )$$

By complying with Condition (II), the domain of the above-mentioned implicit function ƒ( [symbol] ) is expandable by iteratively repeating the following steps: 1) selecting one new equilibrium of on the boundary of the neighbourhood to satisfy Condition (I); 2) then satisfying Condition (II) based on the new equilibrium again.

By iteratively expanding the domain, the operating point can be expanded throughout a set of manifolds that consistently complies with (8) and Condition (II); hence the existence of equilibrium is ensured throughout this aggregated manifold. This process is aligned with the principle of analytic continuation [11]. Substituting (8) into (10) yields:

$$\vert G + K - INVS \vert \neq 0 \qquad ( 11 )$$

where INVS is an n×n diagonal matrix, whose diagonal element on ith row, INVSᵢᵢ (0<i≤n) is

$$\frac{- {P}_{refi}}{{V}_{i 0}^{2}} .$$

Define Gₑₓ as the extended conductance matrix with:

$${G}_{ex} = G + K - INVS \qquad ( 12 )$$

For a practical HVDC network, the operating points of power must be bounded. To ensure the condition of (10) (i.e., the existence of equilibrium) consistently stands within a bounded space of power vector defined by:

$$P = \{ {P}_{ref 1} , {P}_{ref 2} , … , {P}_{refn} \vert {P}_{mini} \leq {P}_{refi} \leq {P}_{maxi} \} \qquad ( 13 )$$

any one of the following two conditions should exclusively stand for all eligible operating points ( [symbol] , [symbol] ) that satisfies the condition of [symbol] ∈P:

Condition 1 in which the determinant of Gₑₓ is positive:

$$\vert {G}_{ex} \vert > 0 \qquad ( 14 )$$

Condition 2 in which the determinant of Gₑₓ is negative:

$$\vert {G}_{ex} \vert < 0 \qquad ( 15 )$$

And therefore, the operational margin against loss-of-equilibrium can be defined as |Gₑₓ|, whose greater value indicate a better margin.

Considering the extended conductance matrix is real and symmetrical by its mathematical definition, Condition 1 (14) can be replaced by a sufficient (enhanced) condition that the extended conductance matrix is positive definite as it will guarantee its leading principal minor of all orders, which include its determinant, are all positive [13],[14], which is expressed as Condition 3 in which Gₑₓ is positive definite:

$${G}_{e x} > 0 \qquad ( 16 )$$

or equivalently ensure the lowest eigen value of Gₑₓ is positive [13, 14]

$${λ}_{min} ( {G}_{e x} ) > 0 \qquad ( 17 )$$

Similarly, Condition 2 (15) can be replaced by an enhanced condition of consistent negative definiteness of the extended conductance Gₑₓ throughout the space of P as Condition 4 in which Gₑₓ is negative definite:

$${G}_{e x} < 0 \qquad ( 18 )$$

or equivalently ensure the highest eigen value of Gₑₓ is negative as:

$${λ}_{max} ( {G}_{e x} ) < 0 \qquad ( 19 )$$

For the enhanced conditions, the operational margin against loss-of-equilibrium can be expressed by Δₘₐₓ(Gₑₓ) or Δₘᵢₙ(Gₑₓ) when the extended conductance matrix, Gₑₓ, is positive definite or negative definite, respectively.

### Initial Equilibrium and Refined Assessment Criteria

The existence of equilibrium in an HVDC system can be guaranteed in every cycle of control by iteratively complying with Conditions (I) and (II) and securing a pre-defined margin with (14), (15), (17), (19). As a start of the iteration, an initial equilibrium of operating point must be guaranteed for Condition (I).

This initial equilibrium can be practically selected as the condition of a no-load condition. Mathematically, such condition is represented by assigning 0 to all the components of [symbol] in (8).

Therefore, the initial operating point to the operating voltage vector [symbol] = [symbol] is solvable from (8) as:

$$\text{?} = - {( G + K )}^{- 1} K \text{?} \qquad ( 20 )$$

as long as the following condition stands [14]:

$$\vert G + K \vert \neq 0 \qquad ( 21 )$$

In an HVDC system, the probability of not satisfying (21) is practically zero. By assigning the nominal value of DC voltage Vₙ(>0) to every component of the voltage reference vector [symbol] , every component of initial voltage [symbol] shall stay at the nominal value and therefore the initial equilibrium is secured to satisfy Condition (I). At this initial condition, there is

$$\text{?} = {G}_{e x i n i} = G + K = {G}_{s} + {G}_{m} + K \qquad ( 22 )$$

where Gₛ is defined as a diagonal matrix of self-conductance of the HVDC network and its diagonal elements Gₛᵢᵢ will be defined as the reciprocal of shunt (self) resistance

$${G}_{s i i} = \frac{1}{{R}_{ii}} {G}_{s i i} ∈ [ 0 , + ∞ ) \qquad ( 23 )$$

Substituting (6) and (23) into (22), one can obtain the elements of the mutual conductance matrix Gₘ as

$$\{ \begin{matrix}{G}_{mji} = {G}_{mij} = - \frac{1}{{R}_{ij}} & ( i \neq j ) \\ {G}_{mii} = {\sum }_{i = 1}^{n} \frac{1}{{R}_{ij}} & ( i \neq j )\end{matrix} \qquad ( 24 )$$

Considering the mutual conductance matrix Gₘ is a Laplace matrix by its definition in (24) and the positivity of all branch resistance, i.e. Rᵢⱼ∈(0, +∞], Gₘ must be semi-positive definite [15]. Thus, for any non-zero n-dimension real vector [symbol] , the quadratic form of Gₘ shall comply with [13, 14]:

$$\text{?} {G}_{m} \text{?} \geq 0 \qquad ( 25 )$$

As a practical design of droop coefficient must be greater or equal to zero, the diagonal elements of the diagonal matrix K must be greater or equal to zero; considering (23), so must GS. Therefore, there is:

$$\{ \begin{matrix}\text{?} {G}_{S} \text{?} \geq 0 \\ \text{?} K \text{?} \geq 0\end{matrix} \qquad ( 26 )$$

Summing up the inequations of (25) and (26) on both sides of the operators, one can write the following to prove the semi-positive definiteness of the extended conductance matrix Gₑₓ at the initial energization condition as

$$\text{?} ( {G}_{m} + {G}_{m} + K ) \text{?} = \vec{X} {G}_{e x i n i} \text{?} \geq 0 \qquad ( 27 )$$

Since the initial condition must be practically included in the expected manifold set of operating power, P, Conditions 2 and 4 above are therefore ruled out from practical scenarios of HVDC operation, as a semi-positive definite matrix Gₑₓᵢₙᵢ can neither have a negative determinant nor eigen value [13],[14]. As a result, the assessment criteria to existence of equilibrium can be reduced to Condition 1 or 3.

### Normalisation of Assessment Margin

Although Condition 1 or 3 can serve as a margin against loss-of-equilibrium, the actual implication of the value may vary significantly with variable structures of circuit or control. One consequence is that it is difficult for an operator to interpret the electrical implication of the resultant margin. This makes it difficult to set up a generic standard in specifying the requirement of an interoperable HVDC system for TSOs. Considering this, two types of normalised index, namely CX-index-I (corresponding to Condition 1) and CX-index-II (corresponding to Condition 3), are created to generically index an HVDC network of any topology and control structure as below:

CX-Index I (in which the determinant of Gₑₓ is positive):

$${Ind}_{C X 1} = \frac{\vert {G}_{e x} \vert}{\vert {G}_{e x o} \vert} \qquad ( 28 )$$

CX-Index II (in which Gₑₓ is positive definite or the lowest eigen value of Gₑₓ is positive):

$${Ind}_{C X 2} = \frac{{λ ( {G}_{e x} )}_{min}}{{λ ( {G}_{e x o} )}_{min}} \qquad ( 29 )$$

Either index in (28) or (29) can adequately indicate the operating condition against loss-of-equilibrium. A value close to 1 indicates a closer operating condition to a risk-free no-load status, whereas a value more towards 0 indicates higher risk of loss-of-equilibrium (voltage collapse).

To obtain the index of (28) or (29), the inputs are droop-coefficients K, network metrics G, (expected or measured) power injections [symbol] , and measurements of terminal voltage [symbol] . As required for interoperability, the information of internal design of converters are not required.

### Inclusion of Supervisory Control

The extended matrix of conductance Gₑₓ can be further expanded by including another component matrix of supervisory droop control, KS as follows:

$${G}_{e x} = G + K + {K}_{S} - INVS \qquad ( 30 )$$

where Kₛ is an n×n matrix. Each of its elements Kₛᵢⱼ defines the weight of the voltage measurement at the jth node (0<j≤n) towards a global reference value in regulating the voltage at ith node (0<i≤n). This component is dispatched by a supervisory control function (or supervisory control functions) based on the feedback of nodal voltage [symbol] via communications between converters and a central control unit (e.g., comprised in the supervisory control, see FIG. 2). The impact of the communications will be reflected by its non-diagonal elements. Since the inclusion of supervisory control does not change the nature of the methodology, K_{S} is assumed to be a zero matrix for simplicity.

### Case Studies

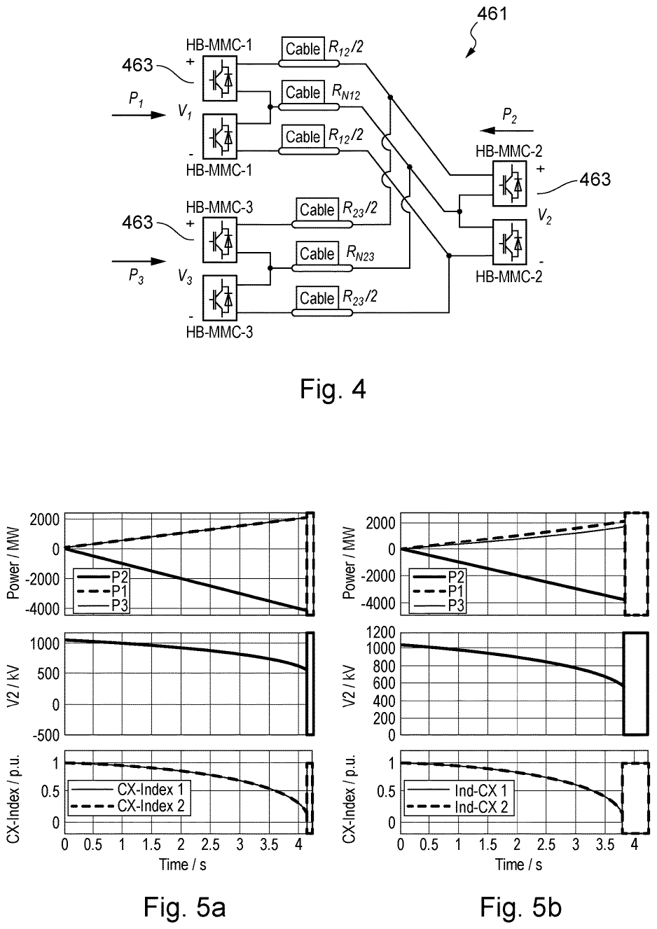

To verify the methodology, a benchmark system was developed for case studies and is illustrated in FIG. 4 with parameters as defined in Table 1 below:

TABLE 1
Initial Parameters of 3-Terminal Benchmark

| Parameter | Value |
|---|---|
| R_{12,} R₁₂ | 10 Ω, 100 Ω |
| Rated voltage | 1050 kV (bipolar) |
| Valve Capacitance | 29 μF (per pole) |
| K₁, K₃ (bipolar) | 8.258 A/kV, 8.258 A/kV |
| Rₙ₁₂, Rₙ₁₂ | 10 Ω, 10 Ω |
| Timesteps of Pseudo- | 100 μs, 3.57 μs |
| steady-state, EMT simulation | |
| MMC Conduction | 0.56 Ω |
| Resistance for EMT | |
| Simulation (per arm) | |

As shown in FIG. 4, a 3-terminal bipolar HVDC network 461 is illustrated with each of the Half-Bridge Multi-Modular-Converters (HB-MMC) 463 having identical current loops at 600 Hz and control frequency at 20 kHz. Lead-lag regulators are used for all DC regulators with lead and lag time constants at 0.004 s and 0.02 s, respectively. Terminal 2 (HB-MMC-2) is assigned as a constant power terminal with proportional gain of power regulator at 0.1 kV/MW and time constant at 0.001 s.

Two types of models were used for time-domain simulations, namely pseudo-steady state DC power flow and EMT. Power flow simulation was carried out with MATLAB/Simulink and EMT with Real-Time-Digital-Simulation (RTDS). For pseudo-steady state simulation, all control and circuits were forced to steady state, i.e., s=0 in the transfer functions; whereas in EMT models, generic average HB-MMC models were used with inter-arm and inter-phase balancing control included [16]. Besides, frequency dependent models of DC cables [17] are used to simulate DC cables in EMT simulations.

### Verification of CX-Indices in DC Power Flow

To verify the proposed index, power ramp tests were carried out based on the benchmark system in FIG. 4 and Table 1. The results are shown in FIG. 5.

As shown in FIG. 5 (a), the system starts with the constant power terminal (Terminal 2) operating at 0 MW at Time=0 s. When a power ramp of −1000 MW/s is applied to P₂, the other two terminals start to accommodate this power demand at the same scale as the droop coefficients and network metrics are symmetrical. As the constant power load grows, the voltage at Terminal 2, V₂, decreases from nominal value, 1050 kV. Meanwhile both CX indexes, Ind-CX 1 and Ind-CX 2 drops from 1, corresponding to no-load condition towards 0, where the voltage collapse occurs at approx. 4.17 s. Once any of the CW-indexes reaches 0, all quantities start to oscillate chaotically.

As a comparison, the ramp test is repeated with droop coefficient of Terminal 3, K₃ reduced by 10% in FIG. 5(b). This is reflected by a lower power sharing of Terminal 3 in accommodating the constant power demand of Terminal 2. As a lower droop coefficient leads to a lower grid strength to accommodate the constant power load, the boundary of DC power transfer is reduced to about 3750 MW and collapses at 3.75 s, where both CW-indexes again reach zero. This collapse is earlier than in the previous case as expected.

Comparison of Pseudo-steady-state and EMT Simulations

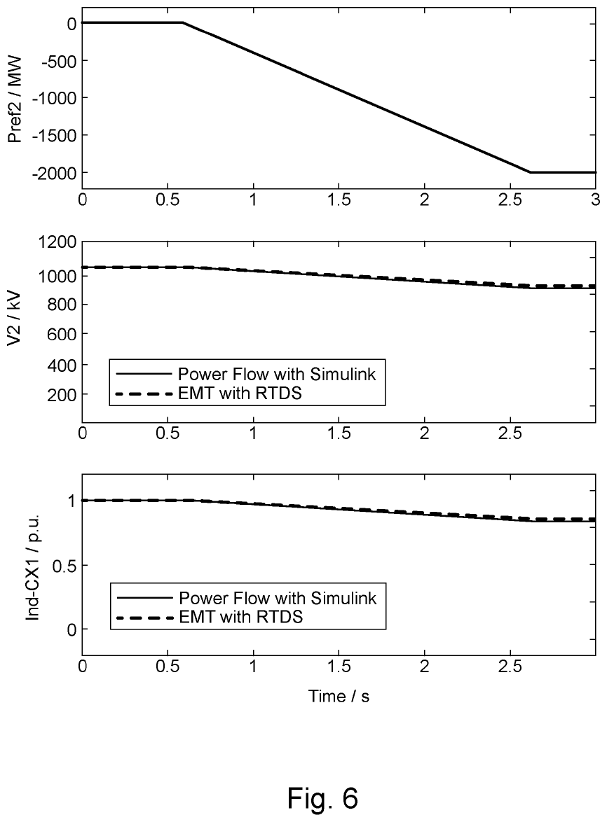

To verify the effectiveness of the CX-index in an EMT simulation, which is closer to real-world performance, a comparison was made based on the case study carried out in FIG. 5(b). The results are shown in FIG. 6. An identical power ramp was enforced at Time=0.6 s. The EMT measurements of voltage at Terminal 2, V2 and CX Index 1, are almost identical to the power flow results with errors of less than 0.2%. Considering the ramp of −1000 MW/s is much more adverse than would be the case in reality and there are still converter losses not counted in DC pseudo-steady state simulations, the accuracy of the CX-index was determined to be satisfactory.

### CONCLUSIONS

The invention provides a MVMT HVDC control paradigm not reliant upon proprietary, confidential or otherwise (potentially) unknowable aspects of a convertor control, verified by simulation under relatively extreme conditions. By definition and solution of the DC network condition based upon the representation of the effect of the convertor control, and a definition of margin in that operation relevant to steady state stability, an overall, vendor-agnostic solution may be obtained in alignment to the TSO priorities for intended operation of a DC network. This therefore allows both the MVMT HVDC control and the associated convertor contributions to it to be described, designed, specified, tested, and deployed with clear definition of individual vendor role and performance. This vendor-agnostic and unified concept of control enables multi-vendor interoperability within a multi-terminal multi-vendor HVDC network.

With reference to the simulation proof outlined above, the proposed indices, namely CX-Index I and CX-Index II, effectively quantify the interactions among converter droop co-efficient present, the DC network metrics and operating points within a HVDC network. Either index can indicate the stability margin against DC power transfer, or equivalently loss-of-equilibrium, with a scalar between 0 and 1.

Defining a control index for each converter provides a number of advantages, not least simplicity in implementation which may for example be programmed as an autonomous function, and reduced demand on computing power means that shorter control cycles can be accommodated resulting in system-wide improvements. Converter-specific normalised indexes can be communicated to the converters as a feedback signal, shifting the burden for optimising the system onto the vendors providing and/or operating the converters but maintaining control on the TSO side as to how the optimised system should be defined (e.g., prioritising stable operation). The TSO does not need knowledge, detailed or otherwise, of the converter design or more complex aspects such as frequency response.

The provision of control index also addresses the issue with existing systems (or attempts to implement them) in that a multi-terminal HVDC system has no inherent or common reference, and would require communication between what might be incompatible resources operated by different vendors, each with their own approach to optimisation, and known systems in which a single, common feedback signal is shared amongst all converter stations based on an overall voltage level in the DC transmission network.

Although this indexing methodology is derived from static behaviour of an HVDC system, real time EMT simulations show that it provides good accuracy in an online assessment form one steady state to a new steady state operation across a transition of a significant power ramp.

In contrast with prior art approaches, the inventive approach rather seeks to quantify the “effect” of the HVDC converter upon the DC system within a multi-terminal control scheme such that a stable operating point across converters can be both identified and instructed that is then resilient across a range of contingencies, including subsequent loss of the multi-terminal control for a given period of time. This effect may be quantified without need to identify sensitive areas of proprietal control structure within the converter itself and will be different across different operating points and control priorities. Across these, the converter in its effect—as seen from the DC system—will either represent a droop-controlled response to a DC voltage or a constant power terminal—providing connection to offshore wind (for example). Other behaviours such as grid forming controls of various applications upon the AC system may be represented by these two above DC-side representative behaviours within a given control tolerance provided/captured within the multi-terminal control. Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

For example, the inventive concept is described with reference to offshore wind connections, but it will be understood that it is equally applicable to other DC grids more generally. Also, as noted above the inventive concept is not limited to application in high voltage DC applications; the principles are also suitable for low- and medium-voltage DC applications. Furthermore, the inventive concept is not limited to MMC converters but may include two- and three-level converters, hybrid converters, and any combination of different converter types as may be appropriate.

### REFERENCES

[1]H. Government. “Net Zero Strategy: Build Back Greener.” Department for Business, Energy & Industrial Strategy. https://www.gov.uk/government/publications/net-zero-strategy.
[2]N. ESO. “The Pathway to 2030 Holistic Network Design.” National Grid ESO. https://www.nationalgrideso.com/future-energy/the-pathway-2030-holistic-network-design.
[3]X. Chen et al., “Integrating wind farm to the grid using hybrid multiterminal HVDC technology,” IEEE Transactions on Industry Applications, vol. 47, no. 2, pp. 965-972, 2010.
[4]T. N. H. Centre. “Caithness-Moray HVDC Project During Delivery.” The National HVDC Centre. https://www.hvdccentre.com/our-projects/caithness-moray/.
[5]A. Shetgaonkar, L. Liu, A. Lekid, M. Popov, and P. Palensky, “Model predictive control and protection of MMC-based MTDC power systems,” International Journal of Electrical Power & Energy Systems, vol. 146, p. 108710, 2023.
[6]M. S. M. Saat, S. K. Nguang, and A. Nasiri, Analysis and synthesis of polynomial discrete-time systems: an SOS approach. Butterworth-Heinemann, 2017.
[7]J. Beerten, D. Van Hertem, and R. Belmans, “VSC MTDC systems with a distributed DC voltage control-A power flow approach,” in 2011 IEEE Trondheim PowerTech, 2011: IEEE, pp. 1-6.
[8]S. Dong, Y. Chi, and Y. Li, “Active voltage feedback control for hybrid multiterminal HVDC system adopting improved synchronverters,” IEEE Transactions on Power Delivery, vol. 31, no. 2, pp. 445-455, 2015.
[9]D. B. Rathnayake et al., “Grid forming inverter modeling, control, and applications,” IEEE Access, 2021.
[10]R. L. Boylestad, Introductory circuit analysis. Pearson Education, 2013.
[11]R. Churchill and J. Brown, Complex Variables and Applications. McGraw Hill, 2014.
[12]S. G. Krantz and H. R. Parks, The implicit function theorem: history, theory, and applications. Springer Science & Business Media, 2002.
[13]A. J. Duran, “On orthogonal polynomials with respect to a positive definite matrix of measures,” Canadian Journal of Mathematics, vol. 47, no. 1, pp. 88-112, 1995.
[14]G. Strang, G. Strang, G. Strang, and G. Strang, Introduction to linear algebra. Wellesley-Cambridge Press Wellesley, MA, 1993.
[15]E. Teufl and S. Wagner, “Determinant identities for Laplace matrices,” Linear algebra and its applications, vol. 432, no. 1, pp. 441-457, 2010.
[16]D. Guo et al., “Detailed quantitative comparison of half-bridge modular multilevel converter modelling methods,” The Journal of Engineering, vol. 2019, no. 16, pp. 1292-1298, 2019.
[17]J. Beerten, S. D′Arco, and J. A. Suul, “Frequency-dependent cable modelling for small-signal stability analysis of VSC-HVDC systems,” IET Generation, Transmission & Distribution, vol. 10, no. 6, pp. 1370-1381, 2016.

1. A method for controlling a plurality of HVDC converters within a multi-terminal HVDC system, the method comprising:
controlling the outputs of the plurality of HVDC converters by providing each HVDC converter with a respective DC voltage reference;
determining a respective feedback signal for each of the plurality of HVDC converters wherein the feedback signals comprise a modification to the DC voltage reference for the respective converter;
wherein determining the respective feedback signals comprises analysing terminal characteristics of each converter and determining an index indicative of a margin against loss of equilibrium.

2. The method of claim 1, wherein the index quantifies the interactions amongst voltage droops between the plurality of HVDC converters.

3. The method of claim 1, wherein the index indicates a stability margin against DC power transfer.

4. The method of claim 1, wherein the modification to the voltage reference is determined to optimise steady state operation of the multi-terminal HVDC system.

5. The method of claim 1, comprising modelling the terminal characteristics of each HVDC converter as an equivalent circuit based on the effect that HVDC converter has in response to a modification of its voltage reference for a given operating state; which may be a Norton equivalent circuit or a Thevenin equivalent circuit.

6. The method of claim 1, comprising determining HVDC system characteristics by constructing a matrix of extended impedance or extended matrix of conductance for the system.

7. The method of claim 1, wherein the method comprises determining DC voltage droop characteristics for each HVDC converter.

8. The method of claim 1, comprising determining an initial value of equilibrium and normalising the index against loss of equilibrium.

9. The method of claim 1, wherein the method comprises determining branch currents and nodal voltages within the system.

10. The method of claim 9, wherein the branch currents and nodal voltages are received at a central controller configured to implement the method.

11. The method of claim 1, wherein the multi-terminal HVDC system is a multi-vendor multi-terminal HVDC system.

12. The method of claim 1, wherein the multi-terminal HVDC system is comprised in an HVDC transmission system.

13. The method of claim 1, wherein the HVDC converters are comprised in an interface or interfaces between one or more HVDC power lines and one or more AC generation systems and/or one or more AC grid networks.

14. (canceled)

15. A method for operating a plurality of HVDC converters within a multi-terminal HVDC system, the method comprising:
controlling the outputs of the plurality of HVDC converters by providing each HVDC converter with a converter specific DC voltage reference;
determining a respective feedback signal for each of the plurality of HVDC converters wherein the converter specific feedback signals comprise a modification to the converter specific DC voltage reference;
wherein determining the respective converter specific feedback signals comprises modelling terminal characteristics of each converter as an equivalent circuit based on or representing the response of that HVDC converter to a modification of its voltage reference for a given operating state.

16. A controller for a multi-terminal HVDC system, the controller adapted or configured to perform the method of claim 1.

17. A multi-terminal HVDC system comprising a plurality of HVDC converters and a controller according to claim 16.

18. The system of claim 17, comprising at least one HVDC power line, at least one HVDC converter between the at least one HVDC power line and an offshore wind farm, and at least one HVDC converter between the at least one HVDC power line and an onshore AC grid.

19. The system of claim 17, wherein the system is a multi-vendor multi-terminal HVDC system.

20. The system of claim 17, wherein the at least one HVDC converter comprises at least one voltage source converter.

21. The system of claim 20, wherein the at least one HVDC converter comprises a nodular multilevel converter.

22-24. (canceled)
